(19) United States
(12) Patent Application Publication
(10) Pub. No.: US 2009/0248566 A1
(43) Pub. Date: Oct. 1, 2009

(54) Spread Matrix Dartboard System and Method for Placing Trade Orders on an Electronic Exchange

(75) Inventor: Darik Miles, Reading (GB)

Correspondence Address: Daniel Brajkovic;RTS Realtime Systems, 311 South Wacker Drive, Suite 980, Chicago, IL, 60606, US

(73) Assignee: RTS REALTIME SYSTEMS SOFTWARE GMBH, Frankfurt/Main (DE)

(21) Appl. No.: 12/416,897

(22) Filed: Apr. 1, 2009

Related U.S. Application Data
(60) Provisional application No. 61/072,647, filed on Apr. 1, 2008.

(51) Int. Cl. G06Q 40/00; G09G 5/08

(52) U.S. Cl. 705/37; 345/163

(57) ABSTRACT

Provided is a system and method for placing trade orders on an electronic exchange using a client terminal. The client terminal includes a user input device and a display device. The method includes displaying a spread matrix on a trading screen of the display device, the spread matrix displaying at least two base dartboards and at least one compound dartboard. The method also includes displaying a market depth of a first tradable instrument on the first base dartboard, displaying a market depth of a second tradable instrument on the second base dartboard, and displaying on the compound dartboard a dynamic display of a plurality of prices of a market depth of a compound. The compound represents a spread market of the first and second tradable instruments. The method further includes displaying a selected-price display on the compound dartboard, the selected-price display displaying a selected price of the plurality of prices in response to detecting a first user action via the user input device, and placing a trade order for the compound at the selected order price on an exchange host system in response to detecting a second user action via the user input device.

### CROSS-REFERENCE TO RELATED APPLICATIONS

This application claims benefit under 35 U.S.C. §119(e) of a U.S. Provisional Application entitled “Spreader Trader Dartboard and Method for Placing a Trade Order for a Tradable Instrument”, filed on Apr. 1, 2008, having application No. 61/072,647.

### BACKGROUND OF THE INVENTION

The present invention generally relates to electronic trading, and more specifically, to a spread matrix dartboard system and method for placing trade orders for on an electronic exchange.

Throughout the world, computerized electronic trading of tradable instruments such as stocks/equities, bonds, futures, options, currencies, warrants, commodities, etc., is replacing traditional face-to-face open-outcry trading. In general, such electronic trading is facilitated using computer network schemes that may include computers hosted by one or more trading exchanges (e.g., CME, CBOT, EUREX), communication servers and/or networks, and end-user computers or electronic terminals. For ease of discussion, the computers and networks hosted by one or more trading exchanges are herein referred to as the “host system,” and the end-user computers or electronic terminals are herein referred to as “client terminals.”

Operations provided by the host system include maintaining order books, order-matching, price discovery and market data distribution for the trading periods as well as nightly batch runs. The host system is also equipped with external interfaces that maintain uninterrupted online contact to quote vendors and other price information systems.

The host system is communicatively coupled to any number of client terminals via corresponding exchange gateways and/or provider server equipment including trading software, which provides an interface between the host system and the client terminal(s). The users of the client terminals, hereinafter referred to as “traders” may include investment banks, proprietary trading firms, individual traders, hedge funds, brokers, market makers, on-line brokers, corporations, clearing companies and the like. Trader access to the host system may be enabled using one of any number communications networks between the client terminal and the host system, including wired and wireless communication networks. Once access is established, data is bi-directionally transmitted between a client terminal and the host system. This allows traders located at the client terminal to establish a connection to the host system via, for example, the Internet.

As is known, the trading exchanges provide volatile tradable instruments having prices that can move rapidly up and down. The slightest speed advantage can generate significant returns in the rapidly moving market, and a trader lacking technologically advanced trading software, including an efficiently configured trading screen, is at a severe competitive disadvantage.

Traders typically use software that generates specialized interactive trading screens on the displays of their client terminals. Such software is typically provided by trading hardware/software providers (“providers”) such as trading exchanges, independent software vendors (ISVs), on-line brokers, investment banks, clearing companies, etc. The interactive trading screens enable the trader to, for example, obtain market data, enter trade orders, cause trade orders to be executed, and monitor positions (e.g., executed trade orders). The range and quality of features available to traders on their trading screens vary according to the specific software application offered by the providers. The installation of open interfaces in an exchange's electronic strategy enables traders to choose, depending on their trading style and internal requirements, the trading software which they use to access the host system.

As is also known, each market supplies the same information to every trader, and requires the same information from every trader. This information, collectively called the market data, includes the market depth of tradable instruments and the quantities and prices of executed trades. The bids (buys) and asks (sells) for each tradable instrument in the market form the market depth for that instrument. A logged-on trader can receive this market depth if the trading exchange provides it. Similarly, every trading exchange requires that certain information be included with each trade order. For example, traders must supply information such as the name of the tradable instrument, quantity, order restrictions, price and multiple other variables when placing a trade order. Without all of the required information, the trading exchange will not accept the trade order for execution.

Traders may employ any number of trading strategies for trading a tradable instrument(s). One of these strategies is generally known as spread trading. In the market for tradable instruments such as options and futures contracts, traders may simultaneously buy and sell tradable instruments in order to reduce risk, or in order to take advantage of a difference in the implied volatilities between two different but related tradable instruments. One type of spread strategy is known as calendar spread trading. A trader employing this strategy will simultaneously buy and sell option and/or futures contracts having the same underlying asset but having different delivery dates. The combination of a bid for a first tradable instrument with a first delivery date and an offer for a second tradable instrument with a second delivery date results in a compound having a price determined by the difference between the bid price and the ask price.

With the aforementioned variables being relatively constant, a competitive speed advantage must come from other aspects of the trading cycle. The steps required to place a trade order for a tradable instrument contribute, in varying amounts, to the total time it takes to place the trade order. For example, the time required for market data to be transmitted from the host system to the client terminal is approximately 10-45 milliseconds, while the time required for a trade order to be transmitted from the client terminal to the host system and for the host system to confirm receipt of the trade order is approximately 10-90 milliseconds. Additionally, the time it takes for the trader to recognize the received market data and to place the trade order is approximately 500-2000 milliseconds. Accordingly, the total time for market data transmittal from the host system, assimilation of the market data by the trader, placement of the trade order based on the received market data and trade order confirmation ranges between approximately one-half of a second to slightly more than two seconds, in a best case scenario.

The market is constantly updating as many traders are placing trade orders, changing trade order and canceling trade orders simultaneously. It fact, successful markets strive to maintain a high volume of trading so that any trader who wishes to enter a trade order will find a match and have that trade order filled quickly. In such liquid markets, the prices of the tradable instruments fluctuate rapidly. On a trading screen, this results in rapid changes in the price and quantity fields within a market grid. If a trader intends to enter a trade order at a particular price, but misses the price because the market prices moved before he could enter the trade order, he may lose hundreds, thousands, even millions of dollars. The faster a trader can place a trade order, the less likely it will be that he will miss his price and the more likely he will make money.

A click-based trading method and system for reducing the time it takes to place a trade order for a commodity is disclosed in U.S. Pat. No. 6,938,011, to Kemp I I et al. ('011 patent) and assigned to Trading Technologies International. The '011 patent utilizes a trading screen having columns of cells where one column includes the market depth of a commodity being traded. The trading screen enables a trader to place trade orders within the market depth with a single mouse click, presumably reducing the time it takes to place a trade order for a commodity.

Use of the trading screen of the '011 patent requires however, that for every new trade order price selected, the trader must move the mouse to align the mouse pointer to a particular buy/bid cell or ask/sell cell displayed on the trading screen, and then select (via the mouse click) the buy or sell trade order at the desired limit price indicated by mouse pointer location. Such alignment requires that the mouse be physically moved either up or down and in most cases, to the left or right side of the trading screen. Accordingly, the precise alignment of the mouse pointer to a particular trading screen cell uses precious seconds; seconds that may determine a good trade verses a bad trade in a rapidly fluctuating market.

### SUMMARY OF THE INVENTION

In general, a spread matrix system and method are provided for placing trade orders on an electronic market. The trade orders can be placed for tradable instruments and/or compounds related to two or more tradable instruments. More specifically, the system and method disclosed and claimed herein utilizes a selected-price display on a spread matrix of a trading screen, where the spread matrix comprises at least two base dartboards and at least one compound dartboard (collectively referred to herein as “dartboards”). Each of the base dartboards displays a market depth comprising information representing orders at an inside market and orders outside of the inside market through a dynamic display of a plurality of prices and a plurality of bid and ask quantities in the market for the tradable instrument. A compound dartboard displays a spread market depth for its related tradable instruments. The selected-price display is configured to display and highlight, for easy viewing, each price selected by a trader for each trade order. The selected-price display may be one of any dynamically updated price display means including a dynamic display window, a dynamic highlighted row or cell of a dartboard, or a dynamically updated button display, to name a few. Each price is “loaded” into the selected-price display via one of a number of ways using the user input device (e.g., computer mouse). As a result, it is not always necessary to physically move the mouse each time a new price is desired for the trade order, and therefore more rapid placement of the trade order is possible.

In accordance with an aspect of the invention, a system and method for placing trade orders on an electronic exchange using a client terminal. The client terminal includes a user input device and a display device. The method includes displaying a spread matrix on a trading screen of the display device, the spread matrix displaying at least two base dartboards and at least one compound dartboard. The method also includes displaying a market depth of a first tradable instrument on the first base dartboard, displaying a market depth of a second tradable instrument on the second base dartboard, and displaying on the compound dartboard a dynamic display of a plurality of prices of a market depth of a compound. The compound represents a spread market of the first and second tradable instruments. The method further includes displaying a selected-price display on the compound dartboard, the selected-price display displaying a selected price of the plurality of prices in response to detecting a first user action via the user input device, and placing a trade order for the compound at the selected order price ion an exchange host system in response to detecting a second user action via the user input device.

Two of the at least three dartboards display a market depth of tradable instruments with a common underlying asset and exchange but having different delivery dates. These dartboards are herein after referred to as the base dartboards. One of the at least three dartboards displayed is a compound dartboard. A compound dartboard displays a market depth of a compound (spread market) difference of prices of the buy side of a tradable instrument in one base and the sell side of a tradable instrument in another base. The base dartboards display a market depth of tradable instruments having information representing orders at an inside market and orders outside of the inside market through a dynamic display of a plurality of prices and a plurality of bid quantities and ask quantities in the market for the tradable instrument. It should be understood that the present invention includes a number of different aspects and/or features which may have utility alone and/or in combination with other aspects or features. Accordingly, this summary is not an exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a diagram of an exemplary electronic trading network including a trading exchange host system and a trading firm system having client terminals.

FIG. 2 is a more detailed diagram of the trading firm system of FIG. 1, according to an embodiment of the invention.

FIG. 3 is an exemplary trading screen that may be utilized by a trader located at a client terminal of the trading firm system of FIG. 2, according to an embodiment of the invention.

FIG. 4 is a more detailed illustration of the spread matrix of the trading screen of FIG. 3.

FIG. 5 is an example of a strategy-type display that may be displayed on the exemplary trading screen of FIG. 3.

FIG. 6 is a method for placing trade orders on an electronic exchange using a client terminal, according to an embodiment of the invention.

### DETAILED DESCRIPTION OF THE PREFERRED EMBODIMENTS

As described with reference to the accompanying figures, the present invention provides a system and method for placing a trade order for a tradable instrument and/or a compound on an electronic market. The system and method include utilizing a cascading series of dartboards to facilitate placing trade orders. The dartboards may be one of two types; either a base dartboard, or a compound dartboard. A tradable instrument's market depth is a selected number of current bid and ask prices (e.g., 10 bid prices and 10 ask prices) and quantities for that particular tradable instrument at that particular instant in time. The compound dartboards display a market depth, which represents the spread market of its related tradable instruments. Unlike prior art methods, the system and method for placing a trade order described herein includes use of the selected-price display to preclude the need to physically move the mouse either up or down and/or to the left or right side of the trading screen each time a trade order is placed. The selected-price display may be one of any dynamically updated price display means including a dynamic display window, a dynamic highlighted row or cell of a dartboard, or a dynamically updated button display, to name a few. Accordingly, use of the selected-price display facilitates rapid placement of trade orders within the market depth.

The present invention is preferably implemented on a personal computer or electronic terminal. It is contemplated that the present invention may also be implemented on any type of microprocessor-based or computing device having a display capability, a user input device, and being communicatively coupled, either directly or indirectly, to one or more trading exchanges.

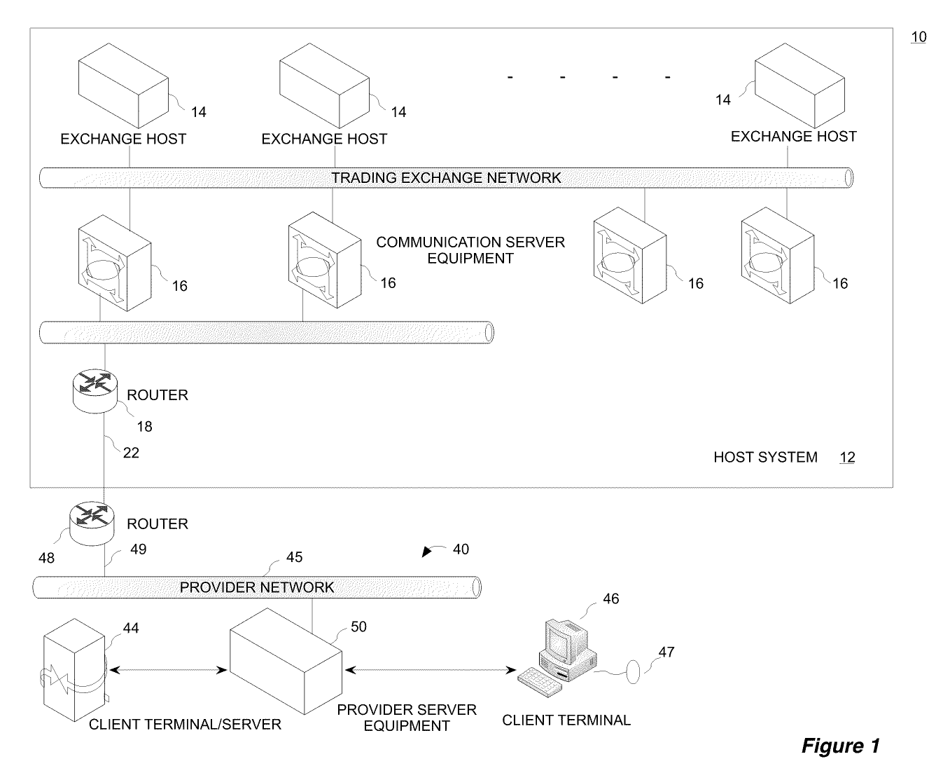

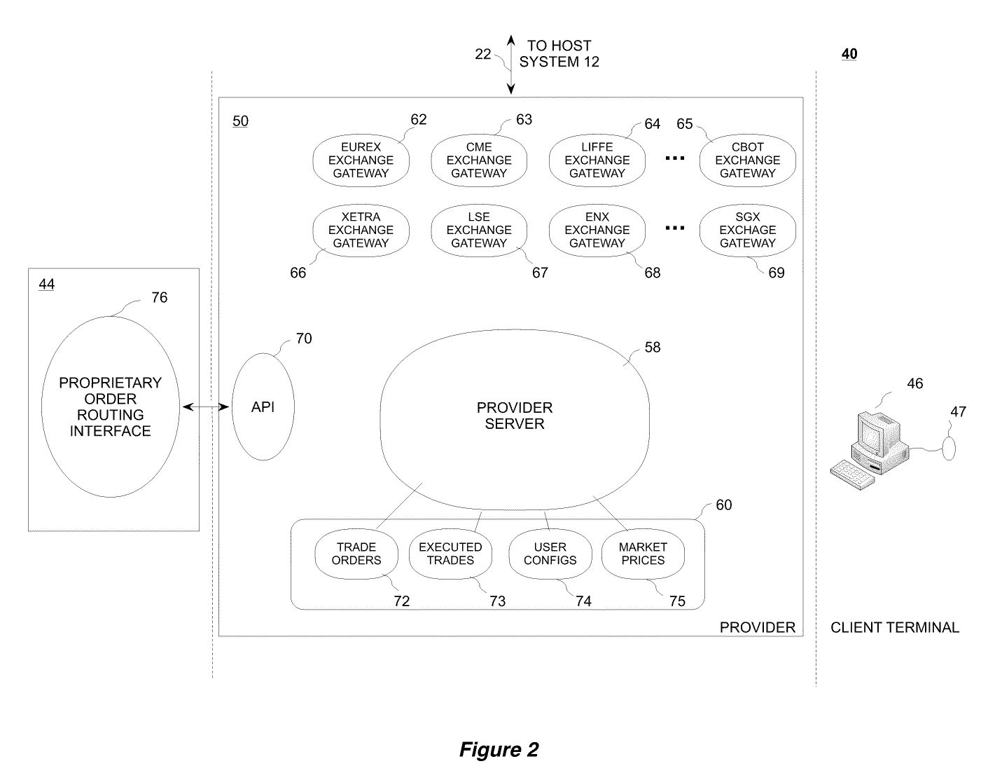

FIG. 1 is a diagram of an exemplary electronic trading network 10 including a trading exchange host system 12 (host system 12) and a trading firm system 40 having a number of client terminals 44, 46. In the illustrated example, the client terminal 44 is shown as a server that includes a proprietary interface (see, FIG. 2). The host system 12 is operatively coupled to the trading firm system 40 via at least one host network router 18 and at least one trading firm network router 48 and a communications link 22 there between. The communications link 22 may be one of any number of suitable communications links such as, for example, a LAN, a WAN, the Internet, etc., to allow communication between the client terminals 44, 46 and the host system 12. Although only one trading exchange host system 12 and one trading firm system 40 are illustrated in FIG. 1, it should be understood that additional trading exchange host systems 12 and/or additional trading firm systems 40 may be included in the electronic trading network 10.

Referring to FIG. 1, the host system 12 includes a number of trading exchange hosts 14 configured to enable execution of trade orders placed by traders via the client terminals 44, 46, to maintain order books, positions, price information, to manage and update trading exchange(s) databases and to provide trading exchange host system data such as market data, market prices and executed trade orders to the client terminals 44, 46. The host system 12 also includes communication server equipment 16 configured to distribute trading exchange host system data to the trading firm system 40 and forward incoming trade orders to the trading exchange host(s) 14, and the host network router(s) 18 configured to route incoming and outgoing data to and from the host system 12.

Although configured with three trading exchange hosts 14, four communication servers 16, and one router 18, it is contemplated that the host system 12 may be one of any number of suitable configurations to enable electronic trading.

The trading firm system 40 includes provider server equipment 50 operatively coupled to the host system 12 via a provider network 45 and the trading firm router(s) 48. As illustrated, the first and second client terminals 44, 46 are operatively coupled to the provider server equipment 50 using well known means (e.g., a LAN, a WAN, wireless networks, Internet). Although only two client terminals are illustrated, it should be understood that many client terminals may be included in the trading firm system 40.

Each of the first and second client terminals 44, 46 is configured to enable electronic trading by one or more traders. For example, the first client terminal 44 may be associated with an on-line broker (e.g., Charles Schwab, ETrade, TD Waterhouse) and therefore be communicatively coupled to a number of personal computers (via, for example, the Internet) to allow traders to place trade orders from, for example, their home or office. The second client terminal 46 may be associated with a trading firm and may therefore be located in a trading firm's office, a third party location or a trading exchange building to enable the trader to place trade orders.

In the illustrated example, the second client terminal 46 includes a user input device 47. Although preferably a computer mouse having a primary, or right button to enable a right click, a secondary, or left button to enable a left click and a scroll device (e.g., a center scroll wheel) wheel to enable one dimensional scrolling, the user input device 47 may be one of any number of suitable input devices capable of manipulation by a trader for the purpose of placing trade orders (e.g., a keyboard/key pad, a biometric input device).

The provider server equipment 50 and its associated software may be provided by one of any number of entities. For example, the provider server equipment 50 and associated software may be provided by a trading exchange, an Independent Software Vendor, an on-line broker, investment bank, a clearing house or any corporation involved in electronic trading, to name a few. In general, the provider server equipment 50 includes a provider server(s), a database(s), one or more application program interfaces (API) and one or more exchange gateways.

More specifically, FIG. 2 is a more detailed diagram of the trading firm system 40. The trading firm system 40 is configured to enable a trader, via a client terminal, to place a trade order for a tradable instrument on an electronic market of the electronic trading network 10, according to an embodiment of the invention. As illustrated, the provider server equipment 50 includes a provider server 58, a provider database 60 and a number of exchange gateways 62-69. The provider server 58 is configured to route trading exchange host system data to the client terminals 44, 46 and to route trade orders to the host system 12. The provider server 58 also provides market data and executed trade orders to the client terminals 44,46.

A database(s) 60 is included in the provider server equipment 50, and is configured to maintain data associated with trade orders 72, executed trade orders 73, user configurations 74 and market prices 75, to name a few. An API(s) 70 is included to enable data flow between a proprietary order routing interface 76 of the first client terminal 44 and the provider server 58. Each of the exchange gateways 62-69 may include provider software and/or trading exchange software to enable the provider server 58 to communicate with the individual trading exchanges. The exchange gateways 62-69 are configured to translate the different exchange data structures and message types into data structures and message types suitable for use by the provider server 58, and vice versa.

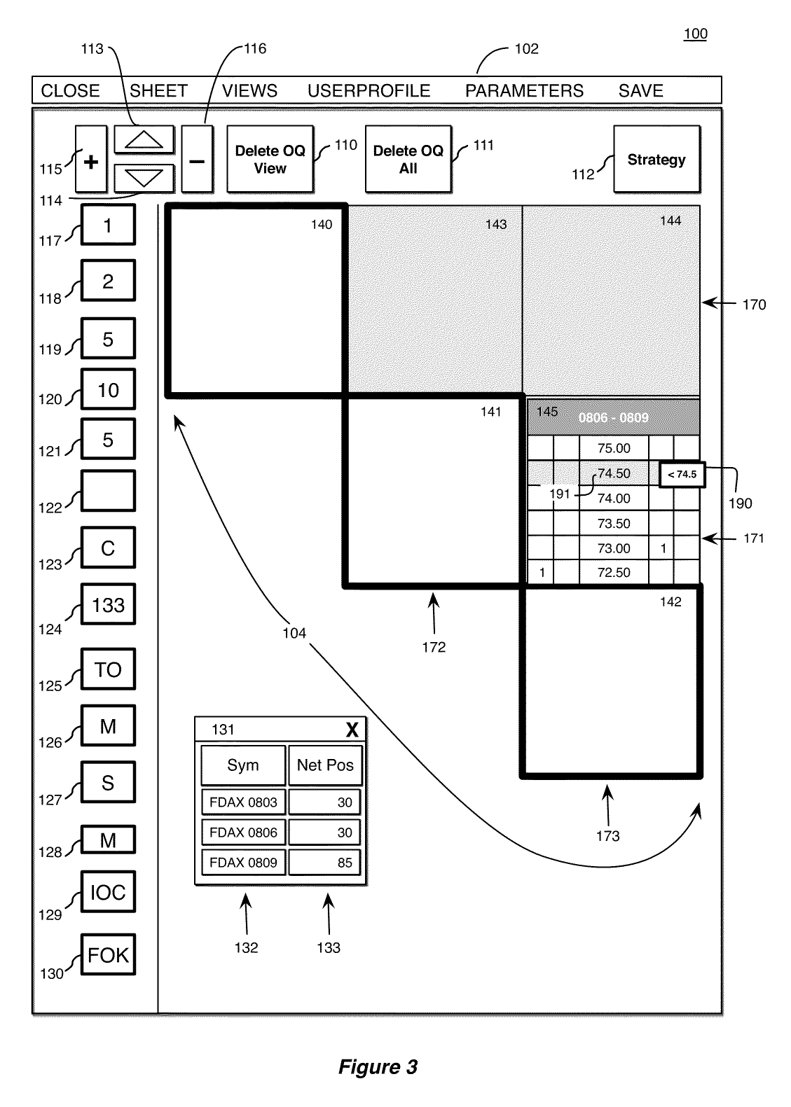

FIG. 3 is an exemplary trading screen 100 that may be utilized by a trader located at a client terminal, such as the client terminal 46, to place a trade order on an electronic market of the trading exchange host system 12, according to an embodiment of the invention. The trading screen 100 may be displayed on any suitably configured display of the client terminal. As described in detail below, the trading screen 100 is configured to enable the trader to place a trade order for a tradable instrument or for a compound. As defined herein, a compound is the result of the combination of a bid for a tradable instrument with a first delivery date and an offer for a related tradable instrument with a second delivery date, where both tradable instruments have a common underlying asset. The market depth of the compound is also referred to as the spread market of the two tradable instruments. Further, although the term “delivery date” is used for ease of discussion, it should be understood that the term as used herein refers, but is not limited, to delivery dates for futures contracts and expiration dates for options contracts.

Referring to FIG. 3, the trading screen 100 includes a menu bar 102 having a number of menu selection buttons (e.g., Views, User Profile) and associated pull-down menus, a number of buttons and button displays 110-130, and a spread matrix 104. In the illustrated embodiment, the spread matrix 104 includes six dartboards 140-145. Three of the dartboards hereinafter referred to as base dartboards 140, 141 and 142, represent the respective markets of three tradable instruments. The other three dartboards, hereinafter referred to as compound dartboards 143, 144 and 145, represent the spread markets of their related tradable instruments.

The spread matrix 104 may be configured with two or more base dartboards and associated compound dartboards, where each base dartboard is a “base” for a “horizontal leg” and/or a “vertical leg”. For example, the base dartboard 140 is the base for a horizontal leg 170; the base dartboard 141 is the base for a horizontal leg 171 and the vertical leg 172; and the base dartboard 142 is the base for a vertical leg 173. As illustrated, each of the compound dartboards 143-145 is located where the horizontal leg of one base intersects the vertical leg of a second base. Further, a compound, represented in a compound dartboard, is related to the tradable instrument represented in its horizontal base and the tradable instrument represented in its vertical base.

A compound may be the creation of an exchange, or host system, or may be the creation of the trader, or client system. If the compound is a creation of an exchange or host system, a trader may place an order for the compound directly with the exchange via his client terminal. If the trader places a trade order for a compound not created by an exchange or host system, the trader's client terminal system can create the trade orders for the related tradable instruments.

Also included on the trading screen 100 of FIG. 3 is a position table 131. The position table enables a trader to see his net positions resulting from executed trade orders in the tradable instruments shown in the current spread matrix 104. The position table includes a symbol column 132 and a net position column 133. The symbol column 132 displays the symbols for each of the tradable instruments in the spread matrix 104. The net position column 133 shows the trader's position in each of the tradable instruments. For example, the position table 131 shows that the trader owns 30 FDAX 0803 contracts, 30 FDAX 0806 contracts, and 85 FDAX 0809 contracts. The positions will change as a result of subsequently executed buy and sell trade orders of the tradable instruments. If an executed trade order was for a compound, the position of the compound's first related tradable instrument will increase and the position of the compound's second related tradable instrument will decrease.

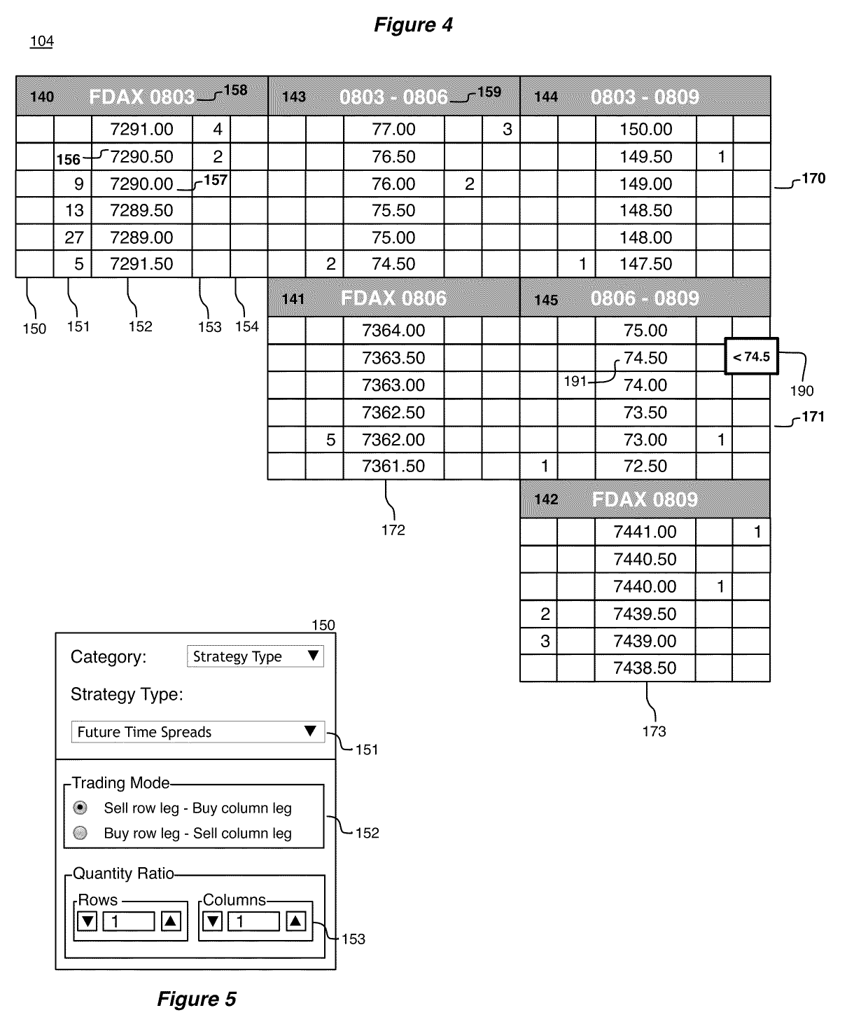

FIG. 4 is a more detailed illustration of the spread matrix 104 of the trading screen 100 of FIG. 3. As discussed above, the spread matrix 104 include a first, second and third base dartboard 140-142 representing three respective tradable instruments, and a first, second and third compound dartboard 143-145. Each compound dartboard 143-145 represents a spread market of two related tradable instruments. For example, the market depth shown in compound dartboard 144 represents the spread market of the tradable instruments of the base dartboard 140 and the base dartboard 142; the market depth shown in compound dartboard 145 represents the spread market of the tradable instruments of the base dartboard 141 and the base dartboard 142. Market depth is defined as information representing orders at an inside market and orders outside of the market through a dynamic display of a plurality of prices and a plurality of bid quantities and ask quantities in the market for any tradable instrument. While the spread matrix 104 of FIG. 4 is illustrated with includes three base dartboards and three compound dartboards, it should be understood that any number of two or more base dartboards and their associated compound dartboards may be included in the spread matrix 104.

Each base dartboard 140-142 and each compound dartboard 143-145 includes five trade order columns, and a title cell associated with and spanning the five trade order columns. For example, the base dartboard 140 includes trade order columns 150, 151, 152, 153, 154, and a title cell 155. Each of the trade order columns 150-154 further includes a plurality of cells.

In the illustrated example, the first trade order column 150 is configured to display one or more trader selected buy trade order quantities associated with a price of the tradable instrument, and the second trade order column 151 is configured to display the quantity of tradable instruments bid for at an associated price. The third trade order column 152 is configured to display a price ladder of the prices of the market depth of the tradable instrument representing prices at an inside market and prices outside (i.e., above and below) of the inside market. For example, a price of 7290.50 displayed in cell 156 is the best or lowest price for a sell trade order (i.e., an ask price). Similarly, a price of 7289.00 displayed in cell 157 is the best or highest price (i.e., a bid price) for a buy trade order. The ask price and bid price displayed in cells 156 and 157, respectively, therefore represent the “inside market”. Those prices displayed above the cell 156 include a list of the next-best ask prices, while those prices displayed below the cell 157 include a list of the next-best bid prices and therefore represent the “outside of the inside market”.

The fourth trade order column 153 is configured to display the quantity of tradable instruments offered at an associated price, and the fifth trade order column 154 is configured to display one or more trader selected ask trade order quantities associated with a price of the tradable instrument. The title cell 155 displays a character string 158 that identifies the type of tradable instrument. The trade order columns and cells of the remaining five dartboards 140-145 are similarly configured. While appearing static, it should be understood that the dartboards 140-145 of FIG. 4 represent a snapshot of a dynamic dartboard with associated price ladders (e.g., trade order column 152) moving upward and downward as the inside market changes.

Referring to the compound dartboards 143-145, rather than displaying a type of tradable instrument, the title cell of each compound dartboard 143-145 displays a numerical string. The numerical string identifies and represents the spread market displayed in its associated compound dartboard, where the spread market is derived from each of the two tradable instruments of the two associated base dartboards. For example, a numerical string 159, displayed as 0803-0806, represents the spread market displayed in the compound cell 143.

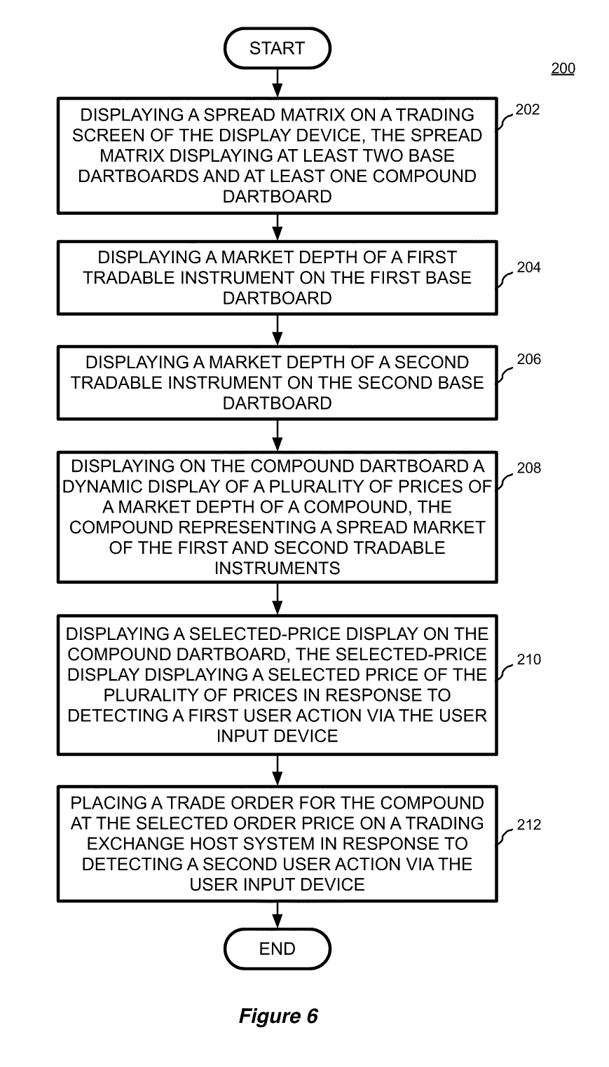

In general, compounds, or spread markets, are calculated based on a strategy selected by the trader from one of several spread strategies. FIG. 6 is an example of a strategy type display 180 that allows a trader to create his or her compounds from one of several strategies. As illustrated, the strategy type display 180 includes a spread selection 181, a trading mode selection 181 and a quantity ration selection 183, and enables the trader to change the type of the compounds he or she wishes to create. For example, the Strategy Type selection 180 offers the choice between future spreads or options spreads 181. The trading mode selection 182 of the strategy type display 180 allows the user to set the mathematical signs of the leg quantities by selecting whether he wants to sell the base of the row leg and buy the base of the column leg or vice versa. Additionally, the user can set the ratio of the leg quantities via the quantity ratio selection 183.

As discussed above, a trader located at a client terminal utilizes a trading screen to enable placement of trade orders and/or compounds. Referring again to FIG. 3, the trading screen 100 further includes a selected-price display 190 to enable enhanced trader viewing of prices he or she selects for placement of trade orders. For ease of discussion, the selected-price display 190 is configured as a dynamic display window. It should be understood however, the selected-price display 190 may also be configured as a dynamic highlighted row where the dynamic highlighted row 191 scrolls in tandem with trader actions via the user input device (e.g., mouse pointer movement, center scroll wheel movement). The selected-price display may also be a dynamic cell of the spread matrix 104, or a dynamically updated button display on or proximate to the spread matrix 104, to name a few examples.

As described in detail below, loading the selected-price display 190 with the trader selected price can be achieved via placement of the mouse pointer over a particular price displayed on the spread matrix 104 and/or scroll wheel movement with the mouse pointer in the spread matrix 104. In the illustrated example of FIG. 3, the dartboards of the spread matrix 104 are configured as vertical dartboards, however, it should be understood that other physical orientations are contemplated.

Referring now to the buttons and button displays 110-130, when the Del OQ View button 110 is selected by the trader, current trade orders displayed in a selected dartboard of the spread matrix 104 are caused to be deleted. Similarly, when the Del OQ All button 111 is selected, trade orders displayed in all dartboards of the spread matrix 104 are caused to be deleted. When the Strategy button 112 is selected, a strategy window such as strategy window 170 (see, FIG. 6) is caused to be displayed. When the Up-arrow button 113 is selected, the contents of one or more of the dartboards of the spread trader matrix 104 are shifted upward. Likewise, when the Down-arrow button 114 is selected, the contents of tone or more of the dartboards of the spread trader matrix 104 is shifted downward.

When the “+” button 115 is selected by the trader, an additional base dartboard and corresponding compound dartboard(s) are caused to be added to the spread matrix 104. For example, if a trader presses the “+” button 115 on the spread matrix 104, the trader can add to the base dartboards 140, 141 and 142, representing instruments FDAX 0803, FDAX 0806, FDAX 0809, respectively, a fourth base dartboard representing the market for a tradable instrument referred to, for example “FDAX 0812.” The fourth base dartboard would form the base of a new leg having the corresponding compound dartboards for compounds “0803-0812,” “0806-0812,” and “0809-0812.” Likewise, when the “−” button 116 is selected, the selected dartboard and any of its legs are removed from the spread matrix 104.

Rather than requiring manual entry of buy quantities and sell quantities for each trade order, the trading screen 100 is configured to allow the trader to pre-define default settings such as the trade order quantity. For example, the default quantity button display 121 displays a pre-defined default setting of the trade order quantity; in the illustrated example, a 5 trade order quantity. Thus, when the default trade order quantity is used, each trade order is expressed in quantities of 5 or multiples of 5 (e.g. 10, 20, 25), depending on the number of mouse clicks. The default trade order quantity may be changed via positioning the mouse pointer over the default quantity button display 121 and either right clicking to add to the default trade order quantity or left click to subtract from the default trade order quantity.

In some cases, it may be desirable to define a new trade order quantity for a particular trade order. Accordingly, trader selection of one or more of the quantity buttons 117, 118, 119, 120 defines the next trade order quantity appearing in the next order quantity display button 122. For example, if the quantity button 120 was selected one time and the quantity button 119 was selected one time, the next trade order quantity is reflected as 15 in the display button 122, and the trade order quantity will be 15 or multiples thereof. Additional functionality includes positioning the mouse pointer over one of the quantity buttons 116-120 and then right clicking and holding to display a menu of other numbers such as 1, 2, 5, 10, 50 and an enter button for custom quantity selection. This provides quicker selection of larger or smaller trade order quantities.

A clear button 123 is also provided to enable the trader to clear the trade order quantity appearing in the next order quantity display button 122. A current positions display button 124 is configured to display a sum of all executed trade orders or positions associated with the tradable instrument, and a TO button 125 is configured to enable the trader to “trade out” of his/her position; that is to offset the sum of all of the executed trade orders associated with the tradable instrument. When selected by the trader, the market order button 126 causes the next trade order to be executed at the market price (preferably the inside market price). When the FOK order restriction button 130 is selected, the next single trade order is either immediately fully filled at the selected price, or not filled at all. When the IOC order restriction button 129 is selected, the next trade order is either immediately fully or partially filled at the selected price, or not filled at all.

When selected by the trader, the stop order button 127 enables execution of either a buy or a sell stop order at a limit price or at a market price, when a selected stop price is reached. For example, to place a buy stop order at a market price (“buy stop order at market”), after left clicking the stop order button 127 and then positioning the mouse over one of the columns of one of the dartboards 140-145 (e.g., compound dartboard 145) to display a price in the selected-price display 190, a left click selects a stop price for the buy stop order at market, where the stop price is equal to the price displayed in the selected-price display 190. The stop price may be changed within the selected-price display 190 via scroll wheel movement with the mouse pointer located in the spread matrix 104 or by moving the mouse pointer to another cell of the in the spread matrix 104. The buy stop order at market will remain passive until the stop price is equal to the last executed trade order price for the tradable instrument, as detected by the trading exchange host system 12. Upon becoming active when the stop price is equal to the last executed trade order price, presumably at the “inside market”, the buy stop order at market will be placed and subsequently executed at the current market price.

Similarly, to place a sell stop order at a market price (“sell stop order at market”), after left clicking the stop order button 127 and then positioning the mouse over one of the dartboards 140-145, such as the compound dartboard columns, to display a price in the selected-price display 190, a right click selects a stop price for the sell stop order at market, where the stop price is equal to the price displayed in the selected-price display 190. The stop price may be also loaded in to the selected-price display 190 via scroll wheel movement with the mouse pointer located in the spread matrix 104 or by moving the mouse pointer to another cell of the in the spread matrix 104. The sell stop order at market will remain passive until the stop price is equal to the last executed trade order price for the tradable instrument, as detected by the host system 12. Upon becoming active when the stop price is equal to the last executed trade order price, the sell stop order at market will be placed and subsequently executed at the current market price.

As noted above, when selected by the trader, in addition to placing buy or sell stop orders at the market price, the stop order button 127 enables placement of either a buy or sell stop order at a selected price. As is known, placing a buy or sell stop order at a selected price (“buy or sell stop order at limit”) requires two prices; a first price is selected as the stop price or trigger price at which the buy or sell stop order at limit becomes active, and second price is selected as the limit price at which the buy or sell stop order limit should be executed. For example, for a buy stop order at limit, the first price determines a stop price at which the buy stop order at limit is activated by the trading exchange host system 12, and a second price determines a limit price at which the buy stop order at limit should be executed. Similarly, for a sell stop order at limit, the first price determines a stop price at which the sell stop order at limit is activated by the trading exchange host system 12, and a second price determines a limit price at which the sell stop order at limit should be executed.

Unlike prior art methods where both first and second prices are selected from a trade order column displaying a price ladder (e.g., trade order column 172 of FIG. 4) via two mouse clicks for either a buy stop order at limit or a sell stop order at limit, the system and method for placing a trade order for a tradable instrument disclosed herein requires only one mouse click. This is achieved via trader pre-selection of one of a number of ticks (i.e., a minimum price increment of the tradable instrument), either upward or downward, depending on whether the stop order at limit is a buy stop order at limit or a sell stop order at limit. Such trader pre-selection of one of the number of ticks may be configured as a default setting.

Referring again to the trading screen 100, the stop order offset button display 128 is associated with the stop order button 127, and displays an “M” as a default setting to indicate that a stop order is one of the buy stop order at market or the sell stop order at market. Additionally, the stop order offset button display 128 may be modified to include a trader selected number of ticks to indicate an offset or difference between the first (stop) price and the second (limit) price. Prior to placing the trade order, the number of ticks may be pre-selected by the trader via entering the number directly into the stop order offset button display 128, or positioning the mouse pointer over the stop order offset button display 128, right clicking and holding to display a ticks menu and then selecting the number of ticks from the ticks menu.

In the case of a buy stop order at limit, after left clicking the stop order button 127 and then positioning the mouse over one of the columns of dartboards 140-145, for example over the rightmost column of the compound dartboard 145, a price in the selected-price display 190, a left click selects a first price for the buy stop order at limit, where the stop price is equal to the first price displayed in the selected-price display 190. The stop price may also be loaded into or changed in the selected-price display 190 via scroll wheel movement with the mouse pointer located in the spread matrix 104. The number of preset ticks automatically determines the second price, or limit price at which the buy stop order at limit should be executed. Although preferably in a one-to-one correspondence with the cells of any of the dartboards of the spread matrix 104, it is contemplated that each of the ticks may correspond to other quantities such as two cells of any of the dartboards 140-145 of the spread matrix 104.

For example, using a buy stop order at limit and referring to the selected-price display 190 of FIG. 3, if the stop price is selected as 74.5 and the trader preset number of ticks is 3, the price at which the buy stop order at limit becomes active is 74.50, and the price at which the buy stop order at limit is executed is 76.00. Similarly, using a sell stop order at limit and referring to the selected-price display 190 of FIG. 3, if the stop price is selected as 74.5 and the trader preset number of ticks is 3, the price at which the sell stop order at limit is activated is 74.50, and the price at which the sell stop order at limit is executed is 73.00.

FIG. 6 is illustrates method for placing trade orders on an electronic exchange using a client terminal, according to an embodiment of the invention. The tradable instrument may be one of a stock/equity, a bond, a future, an option, a currency, a warrant, a commodity, or any other traded financial product.

Referring to FIG. 6, the method 200 includes displaying a spread matrix on a trading screen of the display device, the spread matrix displaying at least two base dartboards and at least one compound dartboard (step 202). The method also includes displaying a market depth of a first tradable instrument on the first base dartboard (step 204), displaying a market depth of a second tradable instrument on the second base dartboard (step 206), and displaying on the compound dartboard a dynamic display of a plurality of prices of a market depth of a compound (step 208). The compound represents a spread market of the first and second tradable instruments. The method further includes displaying a selected-price display on the compound dartboard (step 210), the selected-price display displaying a selected price of the plurality of prices in response to detecting a first user action via the user input device, and placing a trade order for the compound at the selected order price ion an exchange host system in response to detecting a second user action via the user input device (step 212).

As is apparent from the above discussion, the system and method disclosed and claimed herein utilizes the selected-price display 150 on the trading screen 100 to preclude the need to physically move the mouse each time a new price selection is required for a trade order, and therefore enables more rapid placement of a trade order.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

The present invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

In one embodiment, the logical operations of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

What is claimed is:

1. A method for placing trade orders on an electronic exchange using a client terminal, the client terminal including a user input device and a display device, the method comprising:
displaying a spread matrix on a trading screen of the display device, the spread matrix displaying at least two base dartboards and at least one compound dartboard;
displaying a market depth of a first tradable instrument on the first base dartboard;
displaying a market depth of a second tradable instrument on the second base dartboard;
displaying on the compound dartboard a dynamic display of a plurality of prices of a market depth of a compound, the compound representing a spread market of the first and second tradable instruments;
displaying a selected-price display on the compound dartboard, the selected-price display displaying a selected price of the plurality of prices in response to detecting a first user action via the user input device; and
placing a trade order for the compound at the selected order price on an exchange host system in response to detecting a second user action via the user input device.

2. The method of claim 1, wherein the first and second tradable instruments have a common underlying asset and exchange, and wherein the first and second tradable instruments have different delivery dates.

3. The method of claim 1, wherein the trade order is an order to sell a quantity of the compound at the selected price.

4. The method of claim 1, wherein the trade order is an order to buy a quantity of the compound at the selected price.

5. The method of claim 1, wherein the user input device comprises a computer mouse having a primary button to enable a primary click, a secondary button to enable a secondary click and a scroll device to enable scrolling.

6. The method of claim 5, wherein detecting the first user action comprises:
detecting a position of a pointer of the user input device over the compound dartboard; and
detecting movement of the scroll device, the movement causing the trade order price to be displayed in the selected-price display.

7. The method of claim 5, wherein detecting the first user action comprises detecting movement of the scroll device, the movement causing the selected price to be displayed in the selected-price display.

8. The method of claim 5, wherein detecting the first user action comprises detecting a position of a pointer of the user input device over the compound dartboard.

9. The method of claim 5, wherein detecting the second user action comprises detecting the primary click with a pointer of the user input device positioned over a price of the plurality of prices.

10. The method of claim 5, wherein detecting the second user action comprises detecting a secondary click with a pointer of the user input device positioned over a bid quantity of a plurality of bid quantities of the compound dartboard.

11. The method of claim 5, wherein detecting the second user action comprises detecting a secondary click with a pointer of the user input device positioned over an ask quantity of a plurality of ask quantities of the compound dartboard.

11. The method of claim 5, wherein the trade order price is changed to another selected price of the plurality of prices in response to detecting movement of the scroll device.

12. The method of claim 1, wherein the first and second tradable instruments are selected from the group consisting of equities, options, futures, warrants, bonds, commodities and currencies.

13. The method of claim 1, wherein the position of the selected-price display is based on the first user action.

14. The method of claim 1, wherein the compound is selected from a group of compounds created in the client terminal.

15. The method of claim 1, further displaying a chooser, the chooser comprising information representing a plurality of tradable instruments through a display of instrument identifiers, instrument types, and contract delivery dates.

16. The method of claim 17, wherein the first and second tradable instruments are selected from the list of tradable instruments in the chooser.

17. The method of claim 1, wherein the at least two base dartboards and the at least one compound board are aligned and arranged in a cascading manner such that a row is created by the first base dartboard and a column is created by the second base dartboard, and the compound dartboard is located at the intersection of the row and column.

18. A computer readable medium having program code recorded thereon for execution on a computer to place a trade order for a compound on an electronic exchange, comprising;
a first program code for displaying a market depth of a first tradable instrument on the first base dartboard;
a second program code for displaying a market depth of a second tradable instrument on the second base dartboard;
a fourth program code for displaying on the compound dartboard a dynamic display of a plurality of prices of a market depth of a compound, the compound representing a spread market of the first and second tradable instruments;
a fifth program code for displaying a selected-price display on the compound dartboard, the selected-price display displaying a selected price of the plurality of prices in response to detecting a first user action via the user input device; and
a sixth program code for placing a trade order for the compound at the selected price on an exchange host system in response to detecting a second user action via the user input device.

19. A computer readable medium having program code recorded thereon for execution on a computer according to claim 18, further comprising program code for establishing that the trade order is an order to sell a quantity of the compound at the selected price.

20. A computer readable medium having program code recorded thereon for execution on a computer according to claim 18, further comprising program code for establishing that the trade order is an order to buy a quantity of the compound at the selected price.

21. A computer readable medium having program code recorded thereon for execution on a computer according to claim 18, further comprising program code for detecting a primary click, a secondary click and a scroll movement of the user input device.

22. A computer readable medium having program code recorded thereon for execution on a computer according to claim 21, further comprising program code for detecting the first user action when a position of a pointer of the user input device is detected over the compound dartboard and when scroll movement is detected.

23. A client system for placing a trade order for a compound on an electronic exchange, the client system having a controller and a memory operatively coupled to the controller, the client system further comprising:
a display device configured to:
display a spread matrix, the spread matrix displaying at least two base dartboards and at least one compound dartboard,
display a market depth of a first tradable instrument on the first base dartboard,
display a market depth of a second tradable instrument on the second base dartboard,
display on the compound dartboard a dynamic display of a plurality of prices of a market depth of the compound, the compound representing a spread market of the first and second tradable instruments;
a user input device configured to:
enable a first user action to cause a selected price of the plurality of prices to be displayed in a selected-price display; and
enable a second user action to cause a trade order for the compound at the selected price to be placed on an exchange host system.
